(19) United States
(12) Patent Application Publication
(10) Pub. No.: US 2007/0186254 A1
(43) Pub. Date: Aug. 9, 2007

(54) Video distribution system and method of managing receiving terminal of video distribution service

(75) Inventors: Hideki Tsutsui, Kanagawa (JP); Miwako Doi, Kanagawa (JP); Tetsuro Muranaga, Kanagawa (JP); Noriaki Koyama, Tokyo (JP); Tetsuya Gotou, Tokyo (JP)

Correspondence Address: Charles N.J. Ruggiero;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 11/524,687

(22) Filed: Sep. 21, 2006

(30) Foreign Application Priority Data
Feb. 6, 2006 (JP) 2006-028969

(51) Int. Cl. H04N 7/173; H04N 7/10; G06F 3/00; G06F 13/00; H04N 5/445; H04N 7/025

(52) U.S. Cl. 725/87; 725/86; 725/46; 725/42; 725/34; 725/35; 725/93; 725/109

(57) ABSTRACT

A video distribution system includes plural receiving terminals, a video distribution apparatus, and a common ID issuing and managing apparatus. Each of the plural receiving terminals has a terminal ID, makes a distribution request for video data, and receives the video data distributed in response to the distribution request. The video distribution apparatus distributes video data to the receiving terminal according to the distribution request. The common ID issuing and managing apparatus includes a common ID issuing unit which issues a common ID and integrates the terminal IDs of the plural receiving terminals by the common ID so that the terminal IDs are treated as a same ID in the common ID issuing & managing apparatus, a common ID storing unit which stores the common ID and the plural terminal IDs in association with each other, and a terminal authenticating unit which checks, when the video distribution apparatus distributes the video data to the receiving terminal in response to the distribution request, whether a common ID is stored in association with a terminal ID of the receiving terminal that sends the distribution request in the common ID storing unit and authenticates the receiving terminal according to the common ID.

### CROSS-REFERENCE TO RELATED APPLICATIONS

This application is based upon and claims the benefit of priority from the prior Japanese Patent Application No. 2006-028969, filed on Feb. 6, 2006; the entire contents of which are incorporated herein by reference.

### BACKGROUND OF THE INVENTION

1. Field of the Invention

The present invention relates to a video distribution system and a method of managing a receiving terminal of video distribution service.

2. Description of the Related Art

Wide-spreading use of broadband is accompanied by an increasing popularity in Video on Demand (VOD) service, which is a video distribution service that realizes real-time distribution of video content such as a movie in response to a request from a user over an internet network that operates based on Internet Protocol (IP) (see, for example, Japanese Patent Application Laid-Opens Nos. H07-107066 and H10-336625).

In recent years, some commercially available television terminals come to be equipped with a VOD function to allow users to enjoy the VOD services. On the other hand, some electronic appliances other than the television terminals are also developed mainly for allowing the user to enjoy audio and video contents provided through analog broadcasting, digital terrestrial broadcasting or the like. One of such appliances is a high-resolution Audio Video Personal Computer (AV-PC). Meanwhile, in Japan, the analog broadcasting is scheduled to be ceased in the year 2011. A ministry considers introducing an IP retransmission of the contents transmitted via digital terrestrial broadcasting,for regions where the reception of digital terrestrial broadcasting is difficult. Empirical experiments are also started with television terminals which can receive digital terrestrial broadcasting via IP connection.

In VOD services, a receiver (user) receives distributed video content by a television (TV) terminal or an AV-PC, and a provider that distributes video content identifies the receiver (user) based on his/her personal information. When the personal information of the user is not available, the provider cannot identify the user. Though each provider manages personal information of the users, such information is not shared among video distributors (providers). On the other hand, the user may view the video contents distributed from plural providers and has a viewing history at each provider. The viewing history of the user at respective providers, however, cannot be combined together since the personal information managed by one provider is not available to outsiders.

The provider may use the bank account number of the user as Identification data (ID) for charging (charging ID). Then, the user's viewing histories at plural video distributing providers might be collectively utilized based on the charging ID. When the viewing histories are gathered, however, the charging ID is attached thereto for the identification. The charging ID here is a meaningful character string, i.e., a bank account number and cannot be made open to outsiders.

Further, when the user buys and uses a new receiving terminal to access the video distributing provider, the user is recognized as a different user at the provider side. Then, the user's viewing history from a previous receiving terminal cannot be utilized integrally.

### SUMMARY OF THE INVENTION

According to one aspect of the present invention, a video distribution system includes plural receiving terminals, a video distribution apparatus, and a common ID issuing and managing apparatus. Each of the plural receiving terminals has a terminal ID, makes a distribution request for video data, and receives the video data distributed in response to the distribution request. The video distribution apparatus distributes video data to the receiving terminal according to the distribution request. The common ID issuing and managing apparatus includes a common ID issuing unit, a common ID storing unit, and a terminal authenticating unit. The common ID issuing unit issues a common ID and integrates the terminal IDs of the plural receiving terminals by the common ID so that the terminal IDs are treated as a same ID in the common ID issuing & managing apparatus. The common ID storing unit stores the common ID and the plural terminal IDs in association with each other. The terminal authenticating unit that authenticates whether the common ID is in the common ID storing unit or not, the common ID being associated with the terminal ID of the receiving terminal to which the video data are to be distributed for the distribution request.

According to another aspect of the present invention, a method of managing a receiving terminal of a video distribution service, includes issuing a common ID from a common ID issuing & managing apparatus for a terminal ID of a receiving terminal to which a video distribution apparatus distributes video data according to a distribution request, the common ID serving for allowing the video distribution apparatus to treat the terminal IDs associated with the common ID as same; and storing and managing the common ID in association with the terminal ID.

### BRIEF DESCRIPTION OF THE DRAWINGS

FIG. 1 is a schematic diagram of an example of a configuration of a VOD system according to a first embodiment of the present invention;

FIG. 2 is a schematic block diagram of a functional structure of the VOD system;

FIG. 3 is an elevational view of an example of video display;

FIG. 4 is a block diagram of an internal configuration of a program/advertisement recommending unit;

FIG. 5 is a block diagram of a modified example of the internal configuration of the program/advertisement recommending unit;

FIG. 6 is a sequence diagram of processing in the VOD system according to the first embodiment;

FIG. 7 is a schematic diagram of an example of data on terminal ID and common ID stored in a common ID managing & storing unit;

FIG. 8 is a schematic diagram of an example of data on subscription information stored by a terminal authenticating unit and a charge managing unit;

FIG. 9 is an elevational view of an example of display of a common TOP screen;

FIG. 10 is an elevational view of an example of display of an authentication/new subscription screen;

FIG. 11 is an elevational view of an example of display of a recommendation confirmation screen;

FIG. 12 is a schematic diagram of an example of data of viewing history information, common ID, and terminal ID managed in association with each other;

FIG. 13 is a sequence diagram of a video distribution process in the VOD system according to the first embodiment;

FIG. 14 is a schematic diagram of an example of information obtained in the video distribution process;

FIG. 15 is a schematic block diagram of a functional structure of a VOD system according to a second embodiment of the present invention;

FIG. 16 is a sequence diagram of processing in the VOD system according to the second embodiment;

FIG. 17 is a schematic diagram of an example of data stored by a program/advertisement recommending unit;

FIG. 18 is a sequence diagram of a video distribution process in the VOD system according to the second embodiment;

FIG. 19 is a schematic block diagram of a functional structure of a VOD system according to a third embodiment of the present invention;

FIG. 20 is a sequence diagram of a process in the VOD system according to the third embodiment; and

FIG. 21 is a schematic diagram of an example of data of subscription information stored by a terminal authenticating unit and a charge managing unit according to the third embodiment.

### DETAILED DESCRIPTION OF THE INVENTION

Exemplary embodiments of a video distribution system and a method of managing a receiving terminal of video distribution service according to the present invention will be described in detail below with reference to the accompanying drawings.

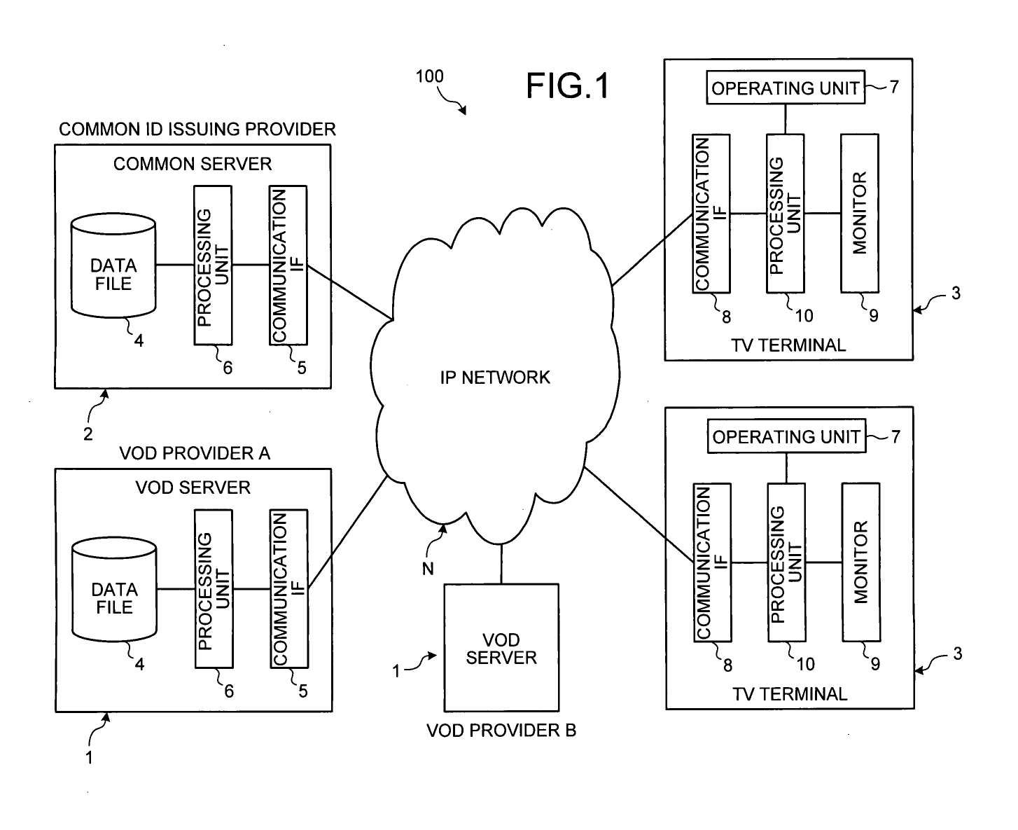

A first embodiment of the present invention will be described with reference to FIGS. 1 to 14.

FIG. 1 schematically shows an exemplary configuration of a VOD system 100 according to the first embodiment of the present invention. As shown in FIG. 1, the VOD system 100, which is a video distribution system, includes a server computer 1 (hereinbelow referred to as VOD server), a server computer 2 (hereinbelow referred to as common server), and plural television (TV) terminals 3 connected to the server computers 1 and 2 via an IP network N. The VOD server 1 is a video distributing apparatus of a VOD provider and realizes distribution service of video data or the like in accordance with a viewing request from the user. The common server 2 is an apparatus which issues and manages common ID and belongs to a common ID issuing provider. The TV terminal 3 is a receiving terminal with which the user receives the video distribution service of the VOD provider. The IP network N is, for example, an internet that operates based on the Internet Protocol (IP). Though in practice there are more than two VOD servers 1 and TV terminals 3, only two VOD servers 1 and only two TV terminals 3 are shown in FIG. 1 for simplicity of description.

As shown in FIG. 1, each of the VOD server 1 and the common server 2 has a data file 4. The data file 4 of the VOD server 1 stores plural pieces of video data as MPEG data, advertisement data as text data, or the like to be provided to each TV terminal 3. The data file 4 of the common server 2 stores sets of common ID, terminal ID, and name of VOD provider, for example. The common ID and the terminal ID will be described later. Each of the VOD server 1 and the common server 2 further includes a communication interface (IF) 5 configured to transmit data via the IP network N, a processing unit 6, and the like. The processing unit 6 includes a Central Processing Unit (CPU), Read Only Memory (ROM), Random Access Memory (RAM), Hard Disk Drive (HDD), or the like. The CPU operates utilizing a work area of the RAM based on a program stored in the ROM or the HDD to execute various processing. When real-time distribution is an important feature, high-speed processing is required. To realize the high-speed processing, it is desirable that a separate logical circuit (not shown) be provided and various computations be realized by the operation of the logical circuit. The VOD server 1 and the common server 2 store different programs in the ROM and the HDD.

The program to be executed by the processing unit 6 may be recorded and provided in an installable or an executable format file in a computer-readable recording medium such as a Compact Disk Read Only Memory (CD-ROM), Flexible Disc (FD), Compact Disk Readable (CD-R), Digital Versatile Disk (DVD), or the like. The CPU in the processing unit 6 reads out the program from the recording medium and loads the read-out program in a main memory, thereby realizing various functions of the VOD server 1 and the common server 2. The program may alternatively be stored in a computer (not shown) connected to the IP network N and downloaded via the network.

On the other hand, the TV terminal 3 has an operating unit 7, a communication IF 8, a monitor 9, a processing unit 10, and the like. When the user of the TV terminal 3 wants to obtain video data from the VOD server 1, the user inputs a transmission request or the like using the operating unit 7. The communication IF 8 transmits various requests to the VOD server 1 and receives video data supplied from the VOD server 1. The received video data is displayed on the monitor 9, such as a Plasma Display Panel (PDP) or a Liquid Crystal Display (LCD). The operating unit 7 may be a remote controller or the like. The processing unit 10 includes a CPU, a ROM, a RAM, or the like not shown, and performs various processing when the CPU operates utilizing a work area of the RAM based on a program stored in the ROM. When a real-time processing is an important feature, it is desirable that a separate logic circuit (not shown) be provided and various computations be performed by the operation of the logic circuit, similarly to the processing unit 6 of the VOD server 1 and the common server 2. Further, the program executed in the processing unit 10 may be recorded in a computer-readable recording medium and provided, or downloaded via a network and provided, similarly to the program executed in the processing unit 6 of the VOD server 1 or the common server 2.

Thus, the VOD system 100 has the above-described configuration. When the user sends a transmission request from the TV terminal 3 to the VOD server 1, which stores various video data in the data file 4 and is connected to the TV terminal 3 via the IP network N, by designating a title of the video data from the operating unit 7, the VOD server 1 reads out the designated video data from the data file 4 and transmits the read-out video data to the TV terminal 3 which is a request sender. On receiving the video data, the TV terminal 3 reproduces and displays the video data, which is supplied from the VOD server 1 online, on the monitor 9. Further, when the VOD server 1 accepts the transmission request for the video data from the TV terminal 3 and distributes the requested video data thereto, the common server 2 of the VOD system 100 issues a common ID for the TV terminal 3 and manages the issued common ID. The detail of the operation of the common server 2 will be described later.

The processing unit 6 of the VOD server 1, the processing unit 6 of the common server 2, and the processing unit 10 of the TV terminal 3 perform various computations. Characteristic computations of the first embodiment among those computations will be described below.

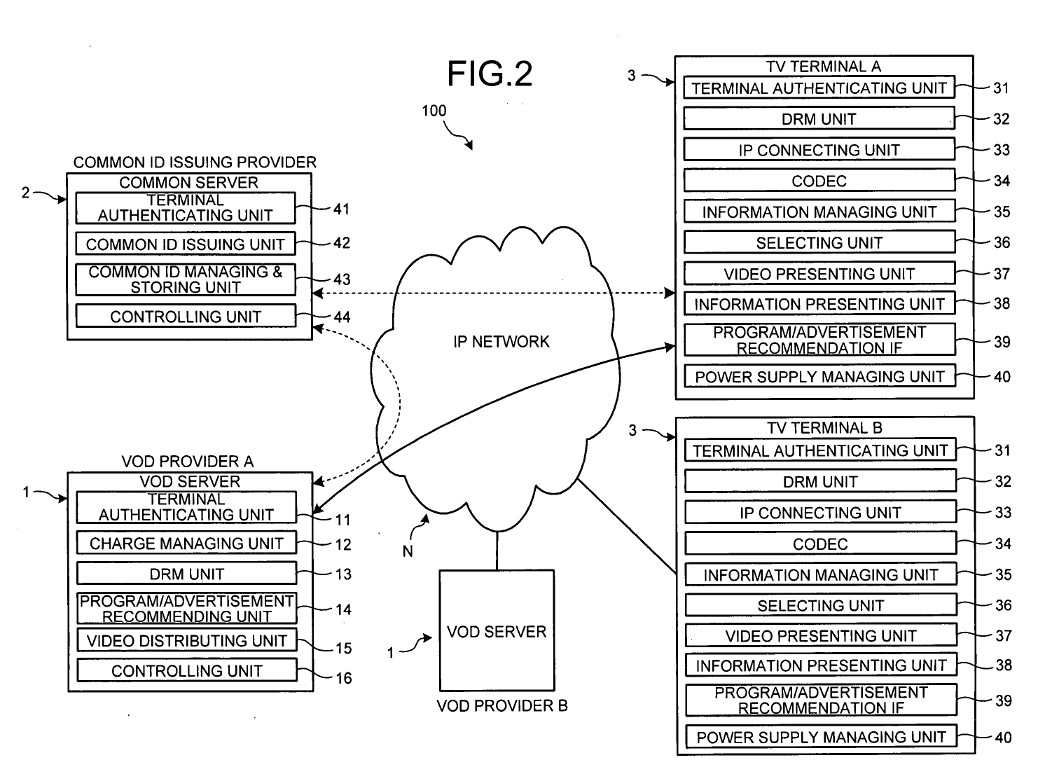

FIG. 2 is a schematic block diagram of a functional structure of the VOD system 100. As shown in FIG. 2, the processing unit 6 of the VOD server 1 includes a terminal authenticating unit 11, a charge managing unit 12, a Digital Rights Management (DRM) unit 13, a program/advertisement recommending unit 14, a video distributing unit 15, and a controlling unit 16 that controls the respective units of the processing unit 6.

The terminal authenticating unit 11 has a function of checking whether the TV terminal 3 is a subscribing receiving terminal or not and authenticating the subscribing receiving terminal. The charge managing unit 12 has a function of charging the TV terminal 3 which is a subscribing receiving terminal according to a distributed video program. The DRM unit 13 has a function of performing copyrights management of a video program to be distributed to the TV terminal 3, i.e., the subscribing receiving terminal.

Further, the video distributing unit 15 serves to distribute video, and has a function of distributing a video program or video data such as advertisement information stored in the data file 4. The program/advertisement recommending unit 14 has a function of recommending each TV terminal 3 to view a program or an advertisement based on information on a video program or an advertisement distributed to the TV terminal 3 by the video distributing unit 15 in the past.

The processing unit 10 of the TV terminal 3 has a terminal authenticating unit 31, a DRM unit 32, IP connecting unit 33, a coder-decoder (CODEC) 34, an information managing unit 35, a selecting unit 36, a video presenting unit 37, an information presenting unit 38, a program/advertisement recommendation IF 39, and a power supply managing unit 40.

The information managing unit 35 has a function of managing information transmission among the terminal authenticating unit 31, the DRM unit 32, the IP connecting unit 33, the CODEC 34, the selecting unit 36, the video presenting unit 37, the information presenting unit 38, the program/advertisement recommendation IF 39, and the power supply managing unit 40.

The terminal authenticating unit 31 stores a terminal ID so that it is possible to check whether the TV terminal 3 is a subscribing terminal or managed by a common ID based on the terminal ID. The terminal authenticating unit 31 has a function of allowing authentication of the TV terminal by the VOD server 1 of the VOD provider and the common server 2 of the common ID issuing provider. The DRM unit 32 has a function of managing copyrights of video received from the VOD server 1. The selecting unit 36 has a function of receiving a selection instruction or the like for video from the operating unit 7. The IP connecting unit 33 has a function of connecting the TV terminal 3 to the VOD server 1 of the VOD provider, transmitting the terminal ID stored in the terminal authenticating unit 31, and receiving video or other information selected by the selecting unit 36. The CODEC 34 has a function of decoding the received video (MPEG data, for example).

The program/advertisement recommendation IF 39 has a function of controlling presentation of information distributed from the program/advertisement recommending unit 14 of the VOD server 1 of the VOD provider and transmitting the information selected by the selecting unit 36.

The video presenting unit 37 is generally called as “player”, and has a function of presenting the video on the monitor 9 after decoded in the CODEC 34. The information. presenting unit 38 has a function of presenting information other than video, such as advertisement or a program listing.

The power supply managing unit 40 has a function of monitoring a cut-off from a power supply.

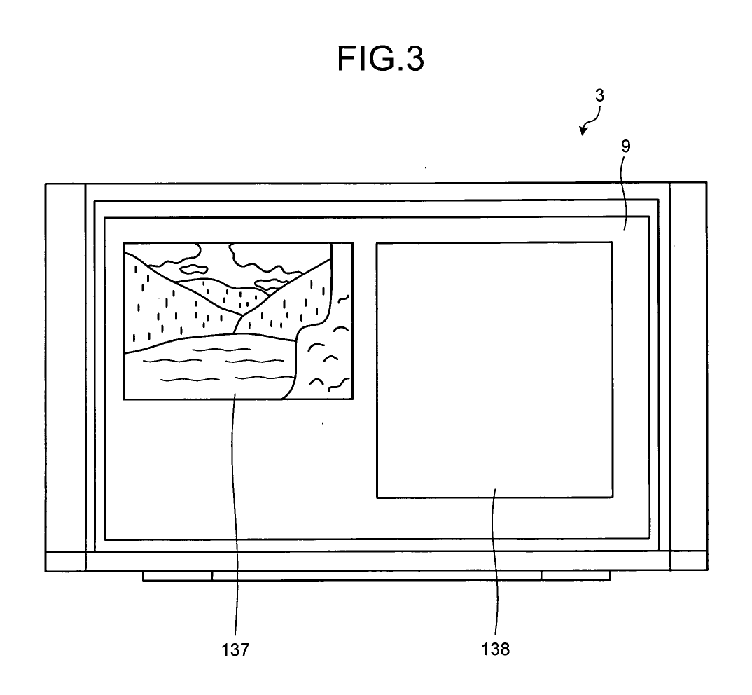

FIG. 3 is an elevational view of an example of a video display on the monitor 9 of the TV terminal 3. In the example shown in FIG. 3, a display area 137 controlled by the video presenting unit 37, i.e., the player, and a display area 138 controlled by the information presenting unit 38 are arranged side by side.

Next, the common server 2 will be described. As shown in FIG. 2, the processing unit 6 of the common server 2 has a terminal authenticating unit 41, a common ID issuing unit 42, a common ID managing & storing unit 43, and a controlling unit 44 that controls the respective units of the processing unit 6.

The terminal authenticating unit 41 has a function of checking whether the TV terminal 3 is managed by the common ID or not and authenticating the TV terminal 3.

The common ID issuing unit 42 has a function of issuing and managing a common ID based on the terminal IDs transmitted from plural TV terminals 3. The common ID is not dependent on a manufacturer or the VOD server 1 of the VOD provider.

The common ID managing & storing unit 43 has a function of storing the common ID issued from the common ID issuing unit 42, the terminal ID of the TV terminal 3, and the VOD server 1 of the VOD provider selected at the selecting unit 36 of the TV terminal 3 in association with each other in a recording medium such as a hard disk drive (HDD).

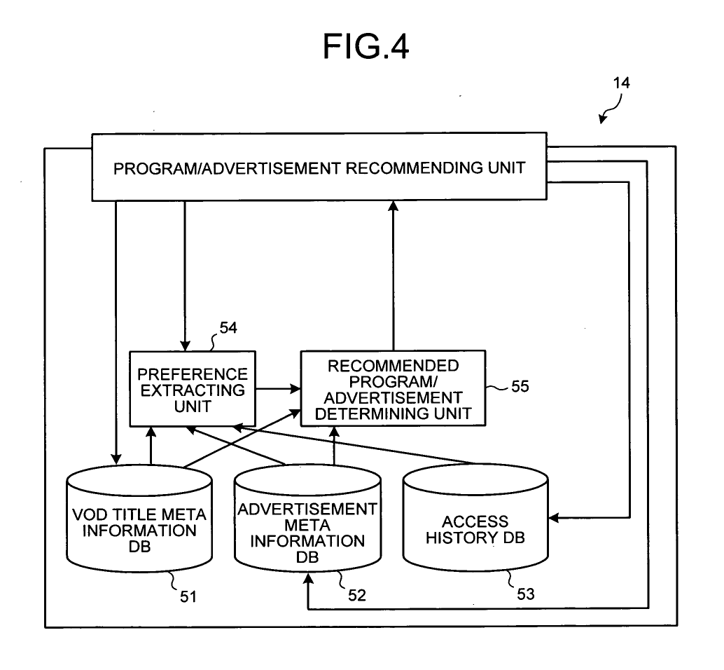

The program/advertisement recommending unit 14 of the VOD server 1 will be described in detail. FIG. 4 is a block diagram of an internal structure of the program/advertisement recommending unit 14. The program/advertisement recommending unit 14 has a function of recommending the user of each of the TV terminal 3 to view a program or an advertisement based on the information on the video program and the advertisement information distributed by the video distributing unit 15 to the TV terminal 3 in the past. As shown in FIG. 4, the program/advertisement recommending unit 14 has a VOD title meta information database (DB) 51, an advertisement meta information DB 52, an access history DB 53, a preference extracting unit 54, and a recommended program/advertisement determining unit 55.

The VOD title meta information DB 51 accumulates meta information of a title of a video program distributed by the video distributing unit 15, so that the accumulated information can be utilized for recommending a program/advertisement. The advertisement meta information DB 52 accumulates meta information of advertisement data (advertisement information) distributed by the video distributing unit 15. The access history DB 53 accumulates access histories of a VOD introduction page, a viewed VOD, a viewed TV program, and a clicked advertisement in association with the terminal ID of each TV terminal 3.

The preference extracting unit 54 extracts preference of the terminal user based on data accumulated in each of the VOD title meta information DB 51, the advertisement meta information DB 52, and the access history DB 53. The recommended program/advertisement determining unit 55 determines which program or advertisement to recommend from the VOD title meta information DB 51 and the advertisement meta information DB 52 based on the preference extracted by the preference extracting unit 54. The preference extracting unit 54 and the recommended program/advertisement determining unit 55 may operate according to some proposed algorithms. For example, a program selection support system determines a program to recommend according to a degree of coincidence or frequency of characteristics of programs user watches; an information searching method and an information searching apparatus perform statistical processing on preference vectors of all users and recommend information suitable for preference of a predetermined group of users depending on the statistic; and another information searching apparatus, an information receiving apparatus, an information searching method learn preference vector of a user based on a viewing history and select one of plural preference patterns.

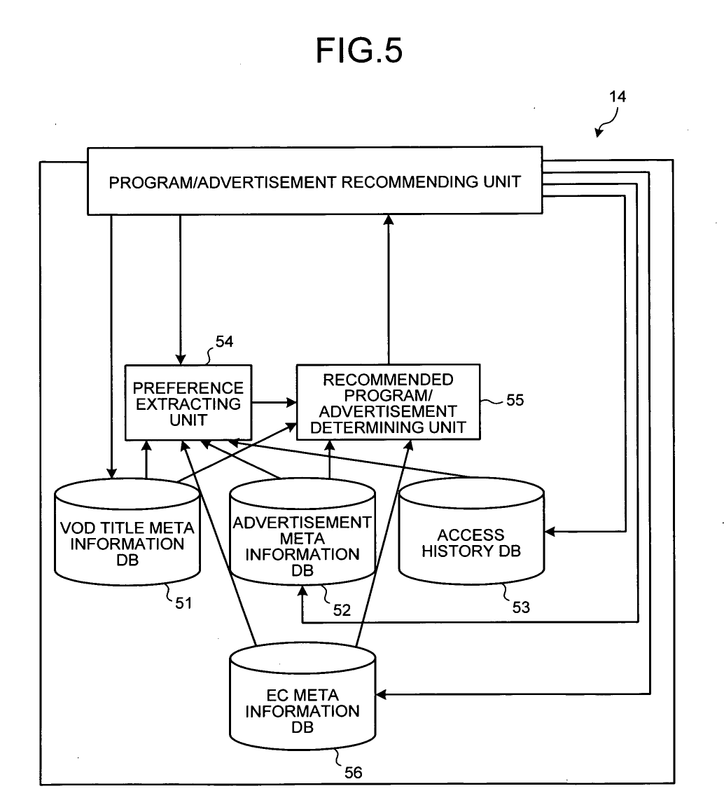

In FIG. 4, the preference is extracted based on the video program or advertisement information that the user watches, though the manner of extraction is not limited thereto. For example, it is possible to utilize information on commodities that the user purchases via Electronic Commerce (EC) after clicking the advertisement. Such extraction can be realized by a configuration as shown in FIG. 5 where a history of purchased products is accumulated in the access history DB 53 and an EC meta information DB 56 accumulating meta information of the purchased products is added to the configuration of FIG. 4.

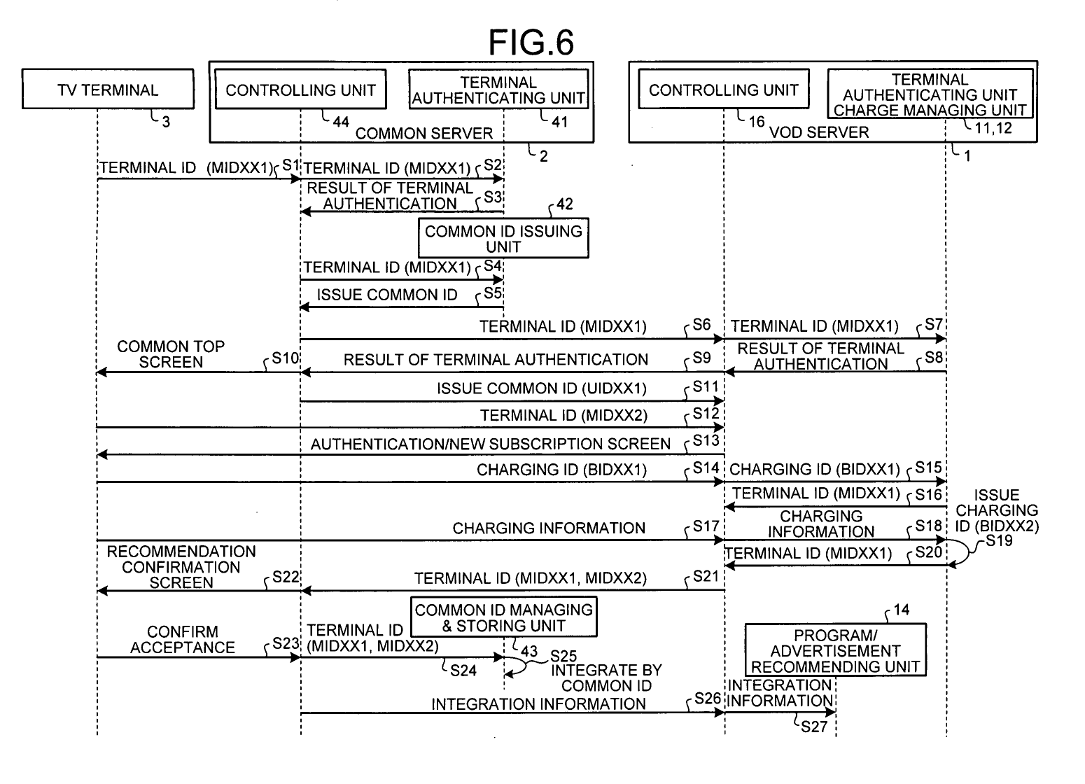

Processing in the VOD system 100 will be described with reference to a sequence diagram of FIG. 6.

First, in the TV terminal 3, an instruction is sent from the operating unit 7 to the selecting unit 36 to connect to the VOD provider. In response to the instruction, the TV terminal 3 sends the terminal ID (MIDXX1) of the TV terminal 3 to the common server 2 of the common ID issuing provider via the IP connecting unit 33 (step S1).

The controlling unit 44 of the common server 2 receives and sends the terminal ID (MIDXX1) to the terminal authenticating unit 41 to check whether the TV terminal 3 is a subscribing receiving terminal or not (step S2).

The terminal authenticating unit 41 of the common server 2 refers to the common ID managing & storing unit 43 to check whether the received terminal ID (MIDXX1) is already stored in the common ID managing & storing unit 43 or not, and sends a result as a terminal authentication result to the controlling unit 44 of the common server 2 (step S3).

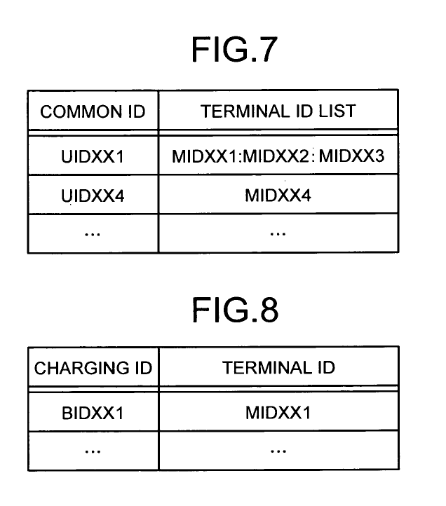

FIG. 7 shows an example of the terminal IDs and the common IDs stored in the common ID managing & storing unit 43. In FIG. 7, one common ID is stored in association with one or more terminal IDs. As shown in FIG. 7, common ID “UIDXX1” is commonly associated with terminal IDs “MIDXX1”, “MIDXX2”, and “MIDXX3”, whereas common ID “UIDXX4” is associated with terminal ID “MIDXX4”. The terminal authenticating unit 41 can check the common ID corresponding to a certain terminal ID by referring to such data. The common ID allows the common server 2 to treat plural terminal IDs (MIDXXX) as the same ID. The common ID (UID) is different from a charging ID (BID).

When the pertinent terminal ID (MIDXX1) is not stored in the common ID managing & storing unit 43, the controlling unit 44 of the common server 2 sends the terminal ID (MIDXX1) to the common ID issuing unit 42 (step S4). On receiving the terminal ID (MIDXX1), the common ID issuing unit 42 makes the common ID managing & storing unit 43 issue the common ID and store the issued common ID in association with the terminal ID, and notifies the issuance of the common ID to the controlling unit 44 of the common server 2 (step S5).

On the other hand, when the pertinent terminal ID (MIDXX1) is already stored in the common ID managing & storing unit 43, and the common ID is issued in step S5, the controlling unit 44 of the common server 2 sends the terminal ID (MIDXX1) to the VOD server 1 of the VOD provider (step S6). In the first embodiment, only two VOD providers are shown for convenience. When plural VOD servers 1 of the VOD providers are connected to the common server 2 that issues the common ID, the process in step S6 is performed for all the VOD servers 1 of the VOD providers.

The controlling unit 16 of the VOD server 1 sends the received terminal ID (MIDXX1) to the terminal authenticating unit 11, which checks whether the terminal is a subscribing receiving terminal or not and authenticates the subscribing receiving terminal (step S7).

The terminal authenticating unit 11 of the VOD server 1 performs authentication of the terminal ID (MIDXX1) sent from the common server 2. When the terminal ID is authenticated, it is notified to the charge managing unit 12. The charge managing unit 12 checks whether the received terminal ID is authentic or not (charge authentication). When the charge managing unit 12 determines that the received terminal ID (MIDXX1) is authentic, it is notified to the controlling unit 16 of the VOD server 1 (step S8). The processing to be performed when the authentication is not successful is not described here.

FIG. 8 shows an example of data of subscription information stored in the terminal authenticating unit 11 and the charge managing unit 12 of the VOD server 1. The subscription information shown in FIG. 8 is a set of the charge ID and the terminal ID. A single terminal ID may be stored in association with one charging ID. Alternatively, plural terminal IDs may be stored in association with one charging ID.

The controlling unit 16 of the VOD server 1 sends a result of terminal authentication to the controlling unit 44 of the common server 2 (step S9).

When plural VOD servers 1 of the VOD providers are connected to the common server 2 of the common ID issuing provider, the common server 2 sends the terminal ID (MIDXX1) to the VOD servers 1 of all the connected VOD providers in step S6, and receives the results of terminal authentication from all VOD servers 1 in step S9.

The controlling unit 44 of the common server 2 that receives the result of terminal authentication opens a common TOP screen on the monitor 9 of the TV terminal 3 in response to the result of above-described processing (step S10). Further, the controlling unit 44 of the common server 2 sends the common ID (UIDXX1) corresponding to the terminal ID (MIDXX1) to the VOD server 1 of the VOD provider, to which the user subscribes, based on the result of terminal authentication (step S11). When the common ID is issued, the VOD server 1 can manage the common ID together with the terminal ID, viewing history, or the like.

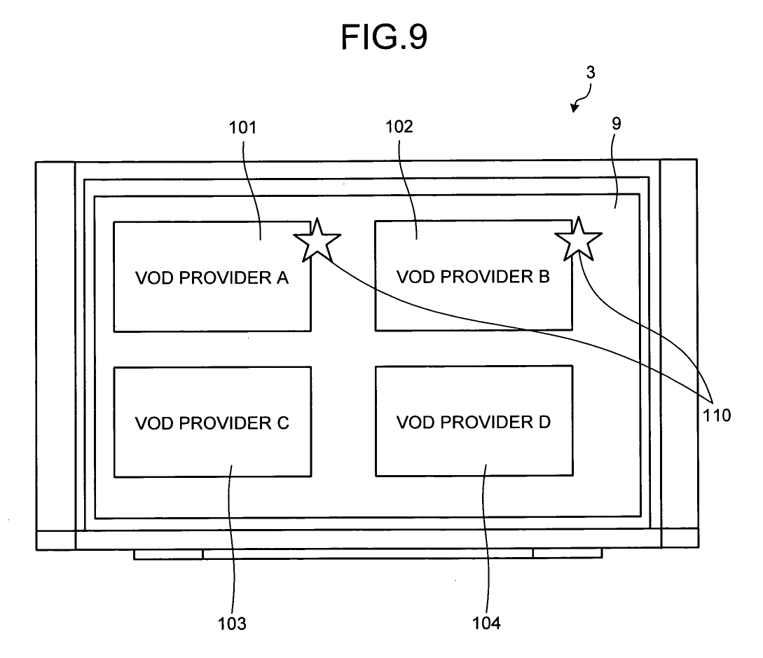

FIG. 9 shows an example of the common TOP screen displayed on the monitor 9 of the TV terminal 3. In the example shown in FIG. 9, the common server 2 of the common ID issuing provider is connected to a VOD server of VOD provider A, a VOD server of VOD provider B, a VOD server of VOD provider C, and a VOD server of VOD provider D. In the configuration as described above, the common TOP screen shown in FIG. 9 shows icons 101 to 104 that serve as links to respective providers A to D. When one of the icons 101 to 104 is selected by a selection instruction supplied from the operating unit 7 to the selecting unit 36, a TOP screen of the VOD server of the selected VOD provider can be shown. In FIG. 9, reference character 110 denotes an authentication mark which indicates that the user is authenticated as a subscriber of the pertinent VOD provider based on the terminal ID (MIDXX1). In the example shown in FIG. 9, the authentication marks are attached to the icons of VOD providers A and B, indicating that the user subscribes to VOD providers A and B. When the user does not subscribe to any of the VOD providers, the authentication mark 110 is not shown at all.

When the selecting unit 36 receives a selection instruction for one of the icons 101 to 104 from the operating unit 7, and the authentication mark 110 is affixed to the icon of the selected VOD provider indicating that the user subscribes to the selected VOD provider, the user can utilize the service from the selected VOD provider since the authentication has already been finished.

On the other hand, when the selecting unit 36 receives a selection instruction of one of the icons 101 to 104 from the operating unit 7, and the authentication mark 110 is not attached to the icon of the selected VOD provider, process proceeds as follows. In the following, the user is assumed to select the VOD provider C to which the user is determined not to have subscribed based on the terminal ID (MIDXX2).

When the VOD provider C to which the user is determined not to have subscribed based on the terminal ID (MIDXX2) is selected, the terminal ID (MIDXX2) is sent from the TV terminal 3 to the VOD server 1 of the VOD provider C (step S12).

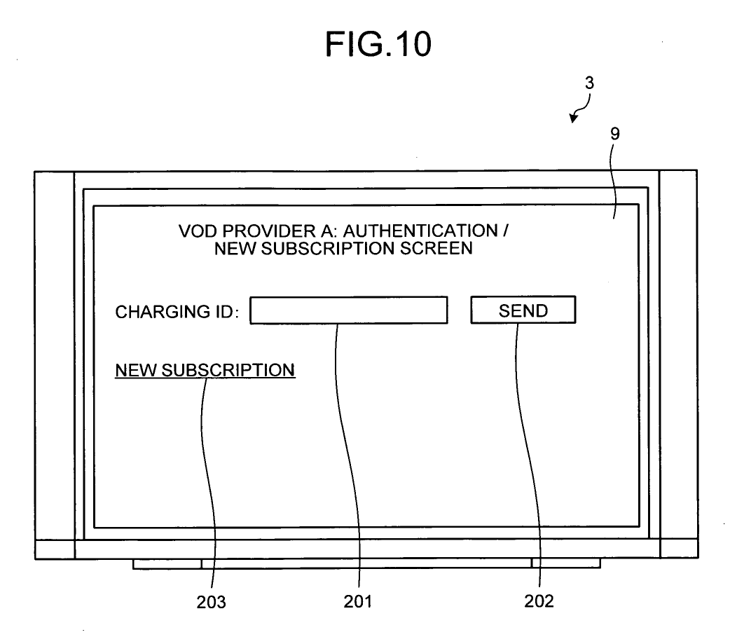

On receiving the terminal ID (MIDXX2), the controlling unit 16 of the VOD server 1 performs authentication of the terminal ID (MIDXX2) similarly to step S7 and step S8. When the terminal ID (MIDXX2) is not included in subscription information as shown in FIG. 8, the controlling unit 16 of the VOD server 1 sends an authentication/new subscription screen as shown in FIG. 10 to the TV terminal 3 and display the same on the monitor 9 (step S13). As shown in FIG. 10, the authentication/new subscription screen has a charging ID input box 201, a charging ID deliver button 202, and a link 203. The user inputs a charging ID in the charging ID input box 201, and gives a transmission instruction of the input charging ID by selecting the charging ID deliver button 202. When the user wants to newly subscribe to the VOD provider C, the user can open a subscription screen by selecting the link 203.

When the user already has the charging ID (BIDXX1) of the VOD provider C, the user inputs the charging ID in the charging ID input box 201 and selects the charging ID deliver button (step S14). In the description, the charging ID is represented as “BIDXX1” for simplicity. The charging ID, however, can be one or more of a name of the user, an address, a bank account number for charging, mail address, and the like, as far as the information can be utilized for charging the user. When the user subscribes to the VOD provider C using a different terminal ID, for example, when the user buys a new terminal, even though the user has the charging ID (BIDXX1) to input in step S14, the authentication mark does not show up in the screen of FIG. 9 displayed on the TV terminal. The user can, however, keep the charging ID.

On receiving the charging ID (BIDXX1) in step S14, the controlling unit 16 of the VOD server 1 sends the charging ID (BIDXX1) to the charge managing unit 12 (step S15). The charge managing unit 12 checks the subscription information as shown in FIG. 8 to see whether the received charging ID (BIDXX1) already exists or not. When the charging ID (BIDXX1) already exists, a terminal ID (MIDXX1) stored in association with the charging ID (BIDXX1) is sent to the VOD server 1 of the VOD provider C (step S16). When plural terminal IDs are stored in association with the charging ID, all the stored terminal IDs are sent to the VOD provider C in step S16. Thus, it can be known that the terminal ID (MIDXX2) and the terminal ID (MIDXX1) are used by the same user. Therefore, the terminal ID (MIDXX1) and the terminal ID (MIDXX2) are stored in association with the charging ID (BIDXX1) as the subscription information shown in FIG. 8 so as to indicate that the terminals with the different terminal IDs have the same charging ID.

On the other hand, when the user selects the link 203 in the authentication/new subscription screen (see FIG. 10) displayed in step S13 in order to open a subscription screen, charging information is sent to the VOD server 1 of the VOD provider C (step S17). The charging information allows the VOD provider C to charge the user for subscription with the VOD provider C. The charging information is sent to the charge managing unit 12 (step S18), which refers to the subscription information as shown in FIG. 8 to check whether the received charging information already exists in the subscription information or not.

When the charging information received by the charge managing unit 12 in step S18 does not exist in the subscription information as shown in FIG. 8, a new charging ID (BIDXX2) is issued. The new charging ID (BIDXX2) is stored in association with the terminal ID (MIDXX2) in the subscription information as shown in FIG. 8 (step S19). Though not specifically shown in the sequence diagram of FIG. 6, the user may be notified of the issued charging ID (BIDXX2).

On the other hand, when the charging information received by the charge managing unit 12 in step S18 already exists in the subscription information as shown in FIG. 8, the terminal ID (MIDXX1) stored in association with the charging ID (BIDXX1) of the corresponding charging information is sent to the VOD server 1 of the VOD provider C (step S20). When plural terminal IDs are stored in association with the charging ID (BIDXX1), all the stored terminal IDs are sent to the VOD server 1 of the VOD provider C in step S20. Thus, it can be known-that the terminal ID (MIDXX2) and the terminal ID (MIDXX1) are IDs for the terminals used by the same user. Hence, terminal ID (MIDXX1) and the terminal ID (MIDXX2) are stored in association with the charging ID (BIDXX1) in the subscription information as shown in FIG. 8 so as to indicate that two terminals have the same charging ID.

When it is known that the terminals identified by the terminal ID (MIDXX1) and the terminal ID (MIDXX2) are used by the same user in step S16 and S20, the terminal IDs (MIDXX1) and (MIDXX2) are sent to the common server 2 of the common ID issuing provider (step S21). On receiving a set of terminal IDs, the common server 2 sends and displays the recommendation confirmation screen on the TV terminal 3 (step S22).

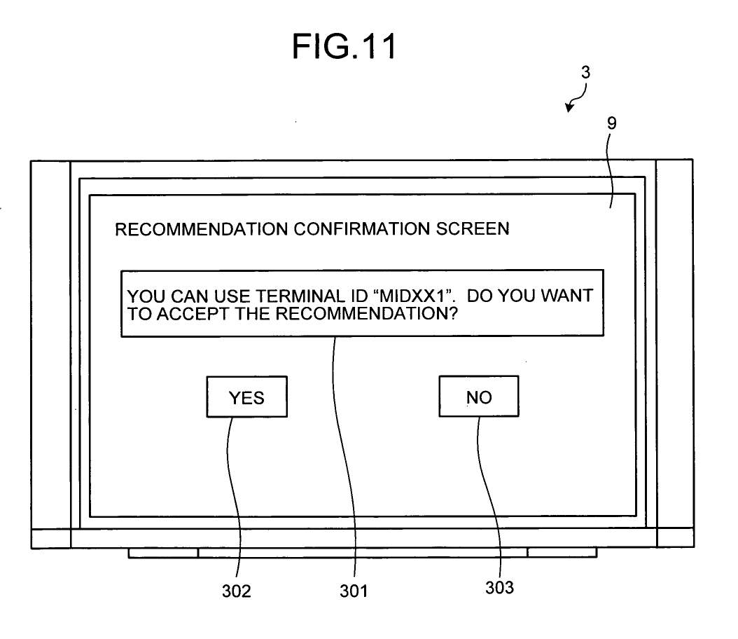

The recommendation confirmation screen shown in FIG. 11 has an information display area 301, a YES button 302, and a NO button 303. The information display area 301 notifies the user that the user can utilize recommendation for the terminal with the terminal ID “MIDXX1”. If the user wants to accept the recommendation, the user selects the YES button 302 by operating unit 7, whereas when the user does not want to accept the recommendation, the user selects the NO button 303 by operating unit 7. Thus, the recommendation confirmation screen can function as a selector which allows the user to select whether to integrally manage the respective IDs by a common ID or not. In FIG. 11, the terminal ID is shown as “MIDXX1” in the information display area 301. When more easily recognizable information can be displayed, for example, a terminal name or a model number of the terminal can be displayed, such information may be displayed in the information display area 301.

When the user selects the NO button 303 in the recommendation confirmation screen of FIG. 11 using the operating unit 7, the terminal IDs are not integrated by the common ID. At this time, the common server 2 of the common ID issuing provider stores the information that the terminal ID (MIDXX1) and the terminal ID (MIDXX2) are managed by different common IDs. Thereafter, even when two terminal IDs are known to belong to the same user, the recommendation confirmation screen shown in FIG. 11 to prompt the user to select whether to integrate the IDs or not is not shown.

On the other hand, when the user selects the “YES” button 302 on the recommendation confirmation screen shown in FIG. 11 by using the operating unit 7, the common server 2 of the common ID issuing provider is notified that the user selects to accept the recommendation (step S23). In response, the controlling unit 44 of the common server 2 sends the terminal IDs (MIDXX1) and (MIDXX2) to the common ID managing & storing unit 43 (step S24).

On receiving the set of terminal IDs (MIDXX1) and (MIDXX2) in step S24, the common ID managing & storing unit 43 searches for the common IDs corresponding respectively to the received terminal IDs based on the data of common IDs and terminal IDs as shown in FIG. 7. When the corresponding common IDs are found, the common ID managing & storing unit 43 integrates the common IDs by granting a new single common ID to the set of terminal IDs and manages the new common ID (step S25). For example, if the common ID managing & storing unit 43 stores and manages two sets of common ID and terminal ID “UIDXX1:MIDXX1” and “UIDXX2:MIDXX2” and integrates two sets, the common ID managing & storing unit 43 comes to store “UIDXX1:MIDXX1, MIDXX2” and manages two terminal IDs by a single common ID (UIDXX1) while discarding the unnecessary common ID “UIDXX2”. Thus, the common ID managing & storing unit 43 realizes a function of changing the common ID. At the integration, the common server 2 of the common ID issuing provider sends information on integration to the VOD server 1 of the VOD provider C (step S26). Further, the controlling unit 16 of the VOD server 1 sends the information on integration to the program/advertisement recommending unit 14. Accordingly, the program/advertisement recommending unit 14 performs integration on information on recommendation managed for each terminal ID (Step S27). Here, the information on recommendation is a viewing history of the user, for example.

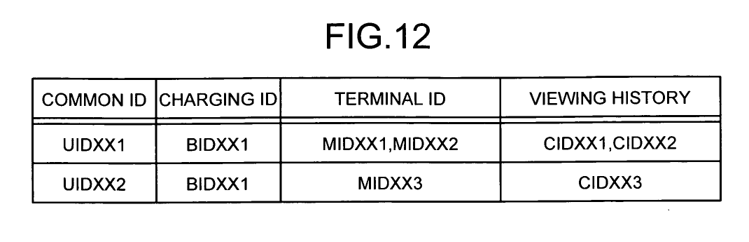

The viewing history may be managed in association with the common ID and the terminal ID. FIG. 12 shows an example of data associating the viewing history, the common ID, and the terminal ID. The example of FIG. 12 consists of the common ID, the charging ID, the terminal ID, and the viewing history, and indicates that the user having a common ID (UIDXX1) watches programs having program IDs (CIDXX1) and (CIDXX2) using a terminal having terminal IDs (MIDXX1) and (MIDXX2). A terminal having a terminal ID (MIDXX3) is managed by a common ID (UIDXX2), and the viewing history shows that the user watches a program having a program ID (CIDXX3) by the terminal having the terminal ID (MIDXX3). Different common ID is assigned to two pieces of data, though a charging ID is the same. It can be assumed that a single user desires to have separate viewing histories. Such history management can be realized when the user selects “NO” button 303 on the recommendation confirmation screen as the example of FIG. 11 in step S22 and selects not to integrate the data.

The viewing history may include, in addition to the program ID shown in FIG. 12, data and time of the program selection, an advertisement ID on advertisement selection, or the like.

Thus, even when the user has plural TV terminals 3, the common server 2 of the common ID issuing provider can manage the user as a single user by utilizing the common ID, and the viewing history and the recommendation information for the user can be integrated so as to cover information at each provider.

The recommendation of the program/advertisement utilizing the common ID will be described below. The program/advertisement recommending unit 14 of the VOD server 1 is supposed to have history data as shown in FIG. 12.

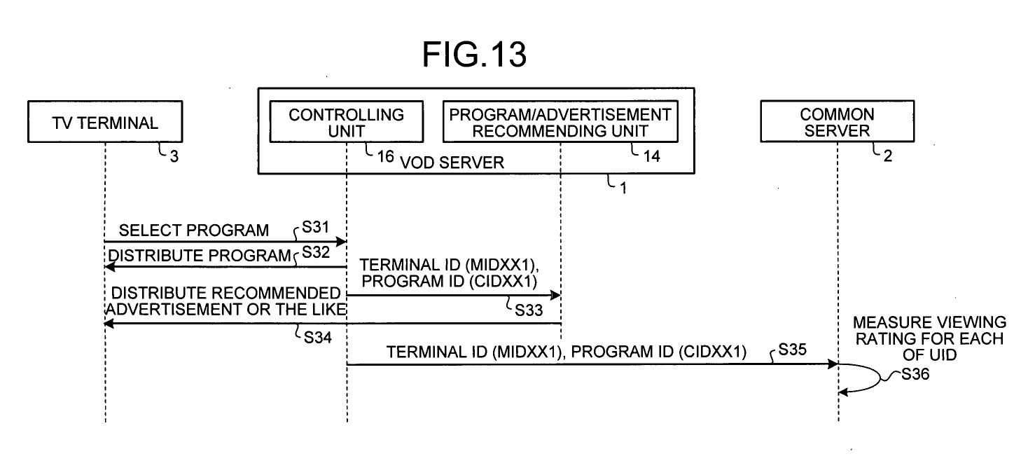

FIG. 13 is a sequence diagram of a video distribution process in the VOD system 100. As shown in FIG. 13, first, the user selects a program he/she wants to watch using the operating unit 7 from a menu screen displayed on the monitor 9-of the TV terminal 3. The menu screen here is Electronic Program Guide (EPG), and the TV terminal 3 has been authenticated based on the terminal ID (MIDXX1) from the VOD server 1 of the VOD provider. Then, the selecting unit 36 is notified of the program selected by the user, and the selected program is sent to the VOD server 1 of the VOD provider (step S31).

The controlling unit 16 of the VOD server 1 of the VOD provider distributes video of the selected program to the TV terminal 3 authenticated by the terminal ID (MIDXX1) (step S32). The video may be distributed by streaming or downloading.

A unique program ID is given to each program by the controlling unit 16 of the VOD server 1 of the VOD provider. In the description, the selected program has a program ID (CIDXX1). The controlling unit 16 of the VOD server 1 sends the program ID (CIDXX1) and the terminal ID (MIDXX1) of the terminal which selects the program to the program/advertisement recommending unit 14 (step S33).

On receiving the terminal ID (MIDXX1) and the program ID (CIDXX1), the program/advertisement recommending unit 14 stores the program ID (CIDXX1) in association with the terminal ID (MIDXX1) in history data, thereby accumulating the viewing history. In the above description, the user selects the program. When the user selects an advertisement, advertisement ID (AIDXX1) of the selected advertisement may be similarly stored in the history data.

The program/advertisement recommending unit 14 calculates which program and advertisement to recommend to the user based on the history data. A manner of calculation is not detailed herein. When many users select the same program as the program selected by a certain user, the program/advertisement recommending unit 14 can calculate which program to recommend by using a collaborative filtering technique. If many users select programs with program IDs CIDXX1, CIDXX2, CIDXX3, and a certain user selects only the programs with program IDs CIDXX1 and CIDXX2, the program/advertisement recommending unit 14 can recommend the user to watch the program with program ID CIDXX3. Further, as one manner of advertisement recommendation, a certain condition can be set for presentation of an advertisement. For example, if an advertisement with an advertisement ID (AIDXX1) is associated with a program with a program ID (CIDXX1), a condition may be set that the advertisement with the advertisement ID (AIDXX1) is presented to the user who selects the program with the program ID (CIDXX1). Then, the program/advertisement recommending unit 14 can recommend presentation of the advertisement with the advertisement ID (AIDXX1) on the TV terminal 3 of the user who selects the program with the program ID (CIDXX1). When the user selects the displayed advertisement, such selection may be stored as a part of the history data. Then, the program/advertisement recommending unit 14 can calculate which advertisement to recommend based on information on the user who has a similar viewing history or a similar history of advertisement selection utilizing the collaborative filtering technique.

When the user performs an operation at the TV terminal 3 requesting a display of a recommended program, or when a predetermined condition for advertisement presentation is satisfied, the VOD server 1 sends one or more program or advertisement selected by the calculation of the program/advertisement recommending unit 14 of the VOD server 1 to the TV terminal 3 for display (step S34).

In addition, the controlling unit 16 of the VOD server 1 sends the program ID (CIDXX1) of the program that is being distributed and the terminal ID (MIDXX1) of the terminal that selects the distributed program to the common server 2 at a predetermined timing as shown in FIG. 13 (step S35). Thus, a ranking of viewing rating covering all programs and advertisements distributed from plural VOD providers can be obtained. Here, “predetermined timing” may be a periodical cycle, such as every one minute or every ten minutes. Alternatively, the controlling unit 16 can send the information immediately after receiving the information on the program selection by the selecting unit 36 of the TV terminal 3 in step S31.

On receiving the terminal ID (MIDXX1) and the program ID (CIDXX1) in step S35, the common server 2 of the common ID issuing provider converts the terminal ID (MIDXX1) to the common ID (UIDXX1). The common server 2 can perform the conversion by using a correspondence table of the common ID (UIDXX1) and the terminal ID (MIDXX1) as shown in FIG. 7. It is described above that the set of terminal ID (MIDXX1) and program ID (CIDXX1) is sent in step S35. When the VOD server 1 of the VOD provider stores the common ID (UIDXX1) for the terminal ID (MIDXX1), the controlling unit 16 may send the common ID (UIDXX1). Then, the common server 2 of the common ID issuing provider does not need to convert the terminal ID (MIDXX1) to the common ID (UIDXX1).

On receiving the terminal ID (MIDXX1) and the program ID (CIDXX1) in step S35, the common server 2 of the common ID issuing provider generates a common program ID for uniquely managing the program ID (CIDXX1) among the providers. For example, the common server 2 can store the program ID in association with the VOD provider ID (PIDXX1) that indicates the VOD provider, or combine the VOD provider ID (PIDXX1) and the program ID (CIDXX1) to generate a common program ID (PIDXX1CIDXX1). There might be VOD providers distributing the same program or the same advertisement. It may be possible to manually attach the same common program ID to the same program or advertisement among VOD providers, and to attach a unique common program ID to program or advertisement distributed by a single VOD provider. In the following it is assumed that the server 2 generates the common program ID (PIDXX1CIDXX2).

Thus, the common server 2 of the common ID issuing provider can obtain ranking of the viewing rating of the programs currently watched for each common ID.

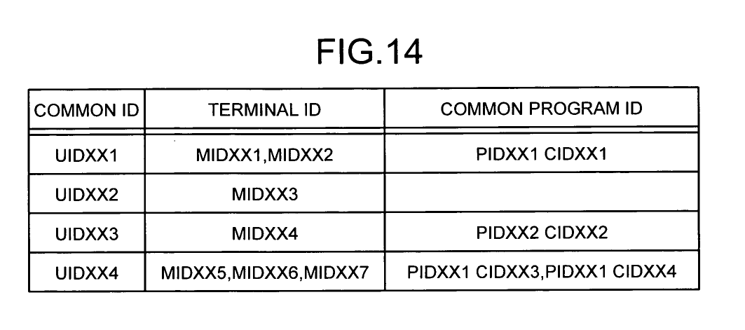

FIG. 14 shows an example of obtained information. FIG. 14 shows common IDs, terminal IDs, and common program IDs. As can be seen from FIG. 14, a common ID (UIDXX1) corresponds to the TV terminals 3 of terminal IDs (MIDXX1) and (MIDXX2), and the user of the TV terminals 3 currently watches a program with a common program ID (PIDXX1CIDXX1). Further, the common ID (UIDXX2) is associated with the terminal ID (MIDXX3), and the TV terminal 3 with the terminal ID (MIDXX3) is not currently playing any program. The common ID (UIDXX3) is associated with the terminal ID (MIDXX4), and the TV terminal 3 with the terminal ID (MIDXX4) is currently playing a program with a common program ID (PIDXX2CIDXX2). The common ID (UIDXX4) is associated with the terminal IDs (MIDXX5), (MIDXX6), and (MIDXX7), and programs with common program IDs (PIDXX1CIDXX3) and (PIDXX1CIDXX3) are currently played.

As can be seen from the above, the common server 2 of the common ID issuing provider can accumulate data on the program IDs of the watched programs. Thus, the ranking of the viewing rating for all programs provided by all VOD providers can be known for each terminal ID without depending on personal information. The ranking can be obtained by counting the number of appearance of a certain program ID(C) in the common program IDs.

In FIG. 14, two programs are simultaneously watched on the terminal associated with the common ID “UIDXX4”. Hence, the appearance of these programs is not counted as one (1) but 0.5, here, and tallied up, whereby the ranking of viewing rating covering all the programs distributed by the VOD providers can be calculated for each common ID. When the ranking of viewing rating of each common ID is divided by the common ID, the viewing rating covering all the programs distributed by the VOD providers can be calculated for each common ID (step S36). Such viewing rating for each common ID represents a viewing rating of each household more accurately than the viewing rating of each terminal ID. The viewing rating of household for each program ID can be represented by a following expression:

viewing rating of household for program ID(C)=Sum at U (number of program IDs (C) of watched programs corresponding to the common ID (U)/number of all watched programs corresponding to the common ID (U)/number of all common IDs

The TV terminal 3 of the first embodiment is provided with the power supply managing unit 40 as shown in FIG. 2. The power supply managing unit 40 monitors whether a power plug is connected to a power supply source at the TV terminal 3 or not. On determining that the power plug is disconnected from the power supply source, the power supply managing unit 40 measures a time of disconnection. Here, the power supply source is a power receptacle of a house, for example, and the disconnection from the power supply source means that the power plug is pulled out from the power receptacle. In the first embodiment, even if the power plug is pulled out from the power receptacle and disconnected from the power supply source, the power supply managing unit 40 still has a battery inside. Therefore, the power supply managing unit 40 can measure the time of disconnection.

Further, the power supply managing unit 40 sets a power supply disconnection flag when the time of disconnection from the power supply source exceeds a predetermined time period. Here, “predetermined time period” may be 24 hours, for example.

When the TV terminal 3 for which the power supply disconnection flag is set is connected to the power supply source again, the TV terminal 3 sends terminal ID (MIDXX1) and the power supply disconnection flag to the common server 2 of the common ID issuing provider. The operation as described above realizes a function of notifying the common server 2 that the time of disconnection exceeds a predetermined time period as well as sending the terminal ID of the pertinent TV terminal 3. On receiving the terminal ID (MIDXX1) and the power supply disconnection flag, the common server 2 searches for a common ID (UIDXX1) corresponding to the terminal ID (MIDXX1) and deletes the terminal ID (MIDXX1) from the terminal IDs associated with the common ID (UIDXX1).

When the TV terminal 3 with the terminal ID (MIDXX1) which is deleted from the group of terminal IDs associated with the common ID (UIDXX1), receives an instruction from the operating unit 7 at the selecting unit 36 to connect to the VOD provider, the process starting at step Si shown in FIG. 6 is performed again. Since the terminal ID (MIDXX1) of the TV terminal 3 is not stored in the common ID managing & storing unit 43, a new common ID may be issued by the common ID issuing unit 42 for the TV terminal 3 of the terminal ID (MIDXX1).

The process as described above functions as a compulsory withdrawal. When such function is provided, the user does not need to delete the terminal ID (MIDXX1) of his/her TV terminal from those corresponding to the common ID when he/she sells the TV terminal 3 with the terminal ID (MIDXX1) to other person. In addition, a new user can efficiently obtain a reissued common ID when starting to use the TV terminal.

According to the first embodiment, the common server 2 of the common ID issuing provider issues a common ID corresponding to a terminal ID of the TV terminal 3 to which the VOD server 1 of the VOD provider distributes video data, so that plural terminal IDs can be recognized as belonging to a single user by the common server 2. The common server 2 stores a combination of the issued common ID and the terminal ID. Thus, even when a single user utilizes plural TV terminals 3, it is possible to manage the plural TV terminals 3 as belonging to the same user by using the common ID and without using a charging ID which is personal information of the user. Here, the common ID serves to allow for the common server 2 to treat the plural terminal IDs as belonging to the same user.

Further, according to the first embodiment, the VOD server 1 of the VOD provider manages information on viewing history related with the distributed video data and the terminal ID of the TV terminal 3 to which the video data is distributed in association with the common ID. Therefore, the server 1 can manage information on viewing history of a user who has plural TV terminals 3 or a user who buys a new TV terminal 3 integrally, whereby the same information on viewing history can be utilized at each of the plural receiving terminals of the user.

Still further, according to the first embodiment, the common server 2 of the common ID issuing provider gathers the information on viewing history corresponding to each common ID stored in the VOD server 1 of each VOD provider, whereby the ranking of the viewing rating covering all the programs distributed by the VOD providers can be known for each terminal ID without depending on the personal information.

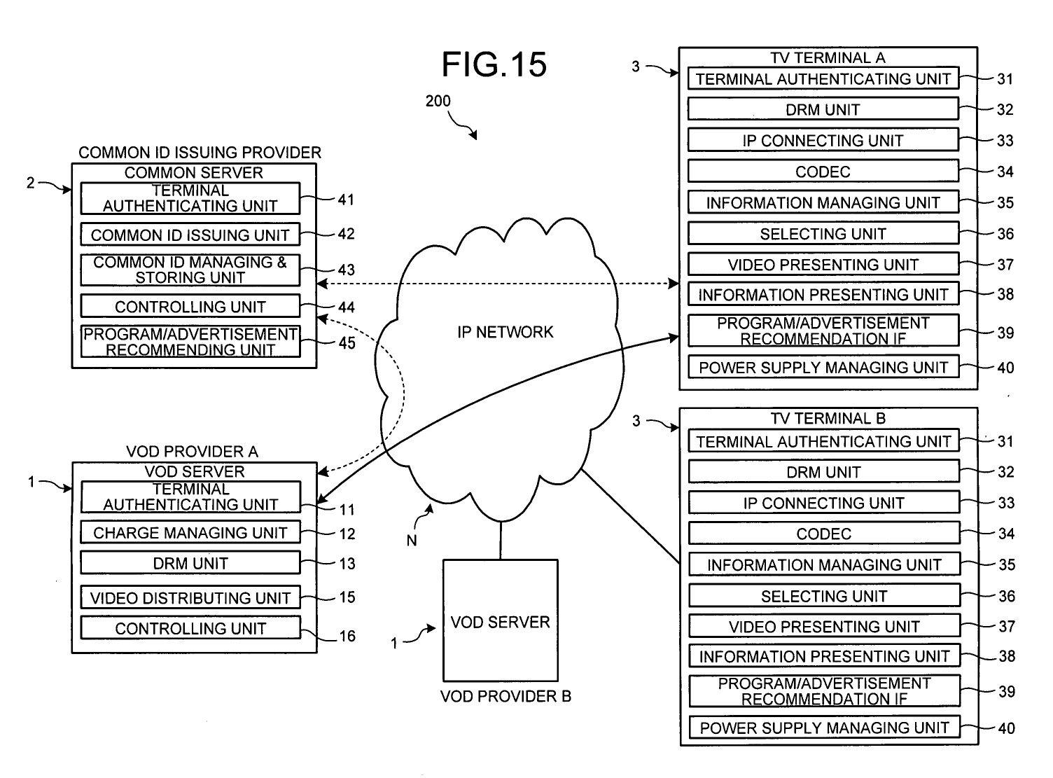

A second embodiment of the present invention will be described with reference to FIGS. 15 to 18. The same components as in the component of the first embodiment will be denoted by the same reference characters and the description thereof will not be repeated.

FIG. 15 is a schematic block diagram of a functional structure of a VOD system 200 according to the second embodiment of the present invention. As shown in FIG. 15, in the VOD system 200 of the second embodiment, the VOD server 1 of the VOD provider does not have the program/advertisement recommending unit 14. In the second embodiment, a program/advertisement recommending unit 45 which has a function of recommending a program or an advertisement is included in the common server 2 of the common ID issuing provider. In this regard, the VOD system 200 of the second embodiment is different from the VOD system 100 of the first embodiment.

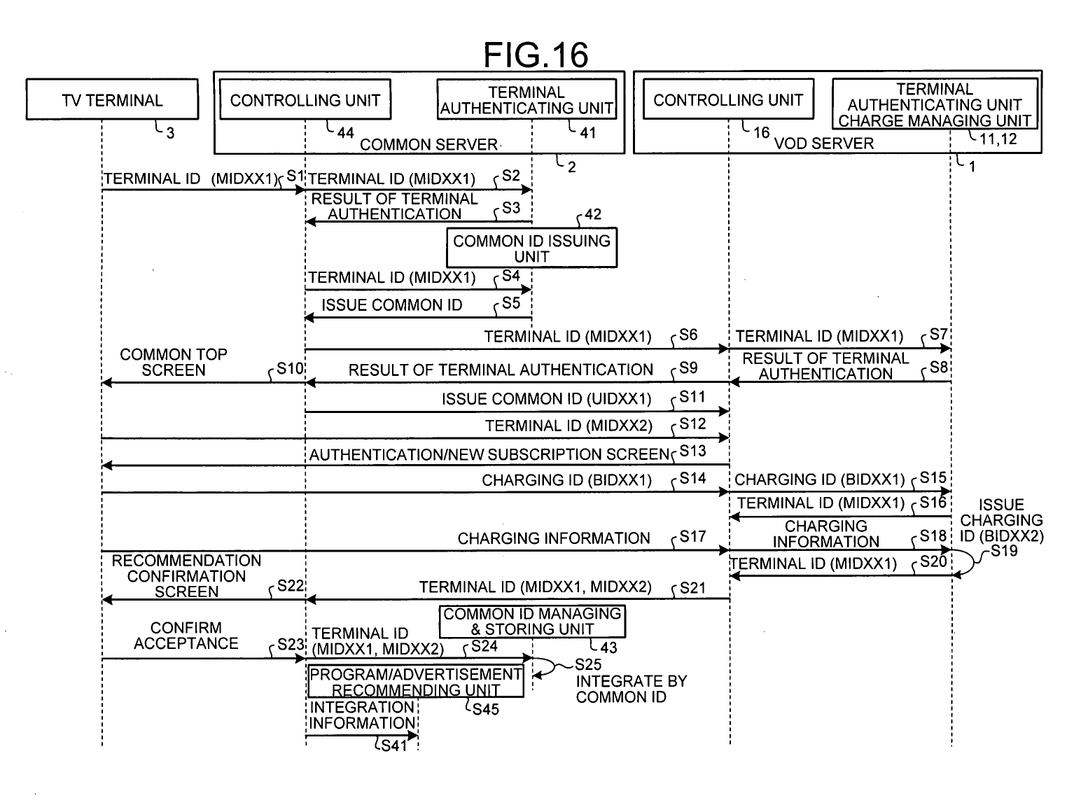

FIG. 16 is a sequence diagram of processing in the VOD system 200. The sequence diagram of FIG. 16 is different from the sequence diagram of FIG. 6 of the first embodiment in the following points.

When the common IDs corresponding to a set of the terminal IDs (MIDXX1, MIDXX2) are integrated in step S25, the information on integration is sent to the program/advertisement recommending unit 45 of the common server 2 of the common ID issuing provider (step S41).

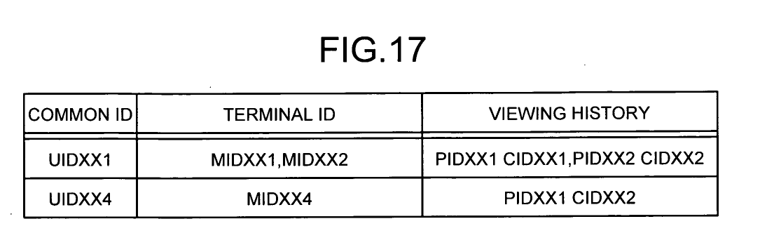

On receiving the information on integration, the program/advertisement recommending unit 45 of the common server 2 integrates the history data accordingly. FIG. 17 shows an example of data stored by the program/advertisement recommending unit 45 at the time. FIG. 17 shows that the program/advertisement recommending unit 45 stores the common ID, the terminal ID, and the viewing history. The common ID (UIDXX1) is associated with the terminal IDs (MIDXX1) and (MIDXX2), and viewing history which is program IDs (PIDXX1CIDXX1) and (PIDXX2CIDXX2). Further, the common ID (UIDXX4) is associated with the terminal ID (MIDXX4) and viewing history which is program ID (PIDXX1CIDXX2). Here, the program ID stored as the viewing history is made unique among plural VOD providers, as described later.

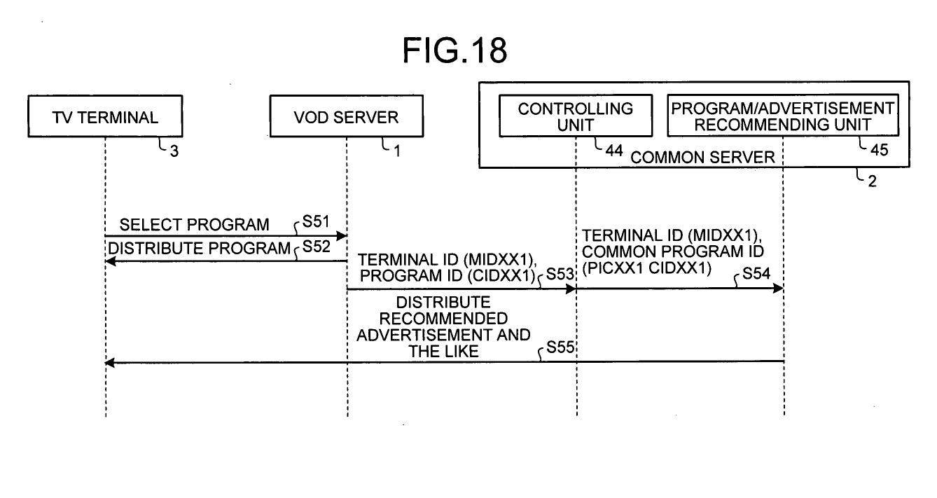

FIG. 18 is a sequence diagram of a video distribution process in the VOD system 200 of the second embodiment. As shown in FIG. 18, first, the user selects a program to watch from the EPG, which is a menu screen, displayed on the monitor 9 of the TV terminal 3 by using the operating unit 7. Here, the TV terminal 3 is authenticated by the VOD server 1 of the VOD provider based by the terminal ID (MIDXX1). Then, the selecting unit 36 is notified of the selected program, and further, the VOD server 1 of the VOD provider is notified of the program selection (step S51).

The controlling unit 16 of the VOD server 1 of the VOD provider distributes video of the selected program to the TV terminal 3 authenticated by the terminal ID (MIDXX1) (step S52). The video may be distributed by streaming or downloading.

Here, a program ID, which is unique among the VOD providers, is associated,with each program by the VOD provider. The program selected by the user in FIG. 18 has unique program ID (CIDXX1). The controlling unit 16 of the VOD server 1 sends program ID (CIDXX1) and terminal ID (MIDXX1) of the TV terminal 3 which selects the program to the common server 2 of the common ID issuing provider (step S53).

The common ID issuing provider generates the common program ID so that the program ID would be unique among the plural VOD providers. For example, the common ID issuing provider stores the program ID in association with the VOD provider ID (PIDXX1) indicating the VOD provider that distributes the program. Alternatively, the common ID issuing provider generates a common program ID (PIDXX1CIDXX1) by combining the VOD provider ID (PIDXX1) and the program ID (CIDXX1).

Here, plural VOD providers may distribute the same program or the same advertisement. A same common program ID may be manually allocated to the same program or the same advertisement distributed by plural VOD providers, whereas a unique common program ID may be manually allocated to a different program or a different advertisement across the VOD providers. In the description below, it is assumed that the common program ID (PIDXX1CIDXX1) is generated.

The controlling unit 44 of the common server 2 sends the terminal ID (MIDXX1) and the common program ID (PIDXX1CIDXX1) to the program/advertisement recommending unit 45 (step S54). The program/advertisement recommending unit 45 receives and stores the terminal ID (MIDXX1) and the common program ID (PIDXX1CIDXX1) as history data. On storing, the program/advertisement recommending unit 45 searches for a common ID corresponding to the terminal ID, and stores the common program ID in the viewing history so that the common program ID is associated with the common ID.

When the program/advertisement recommending unit 45 stores the common ID and the terminal ID as shown in FIG. 17, on receiving the terminal ID (MIDXX1) and the common program ID (PIDXX1CIDXX1), the program/advertisement recommending unit 45 stores the common program ID (PIDXX1CIDXX1) in the viewing history in association with the common ID (UIDXX1) since the terminal ID (MIDXX1) is stored in association with the common ID (UIDXX1). In the above description, the user selects a program. When the user selects an advertisement, the common ID issuing provider can generate a unique common advertisement ID (PIDXX1AIDXX1) based on an advertisement ID (AIDXX1) similarly to the generation of the common program ID, and store the generated common advertisement ID in the history data.

Since the program/advertisement recommending unit 45 stores the history data managed based on the common IDs, the program/advertisement recommending unit 45 can calculate a program and an advertisement to recommend for each common ID. A manner of calculation is similar to the calculation in the first embodiment and will not be detailed here. When the same common program ID can be manually given to the same program/advertisement distributed by plural VOD providers, a program/advertisement to recommend can be calculated more accurately.

When the user operates the TV terminal 3 so as to display the recommended program, or when a predetermined condition to display an advertisement is satisfied, the common server 2 sends one or more program or advertisement selected according to the calculation by the program/advertisement recommending unit 45 of the common server 2 to the TV terminal 3 for display (step S55).

Only programs distributed by the VOD providers to which the user subscribes may be recommended to the user. Alternatively, programs including programs distributed by the VOD providers to which the user does not subscribe may be recommended. When a recommended program is distributed by a VOD provider to which the user does not subscribe, the user can know that a program of his/her preference is distributed by an unsubscribed VOD provider. At the same time, the recommendation can serve as an effective advertisement of the VOD provider to acquire a new subscriber.

Thus, according to the second embodiment, the common server 2 of the common ID issuing provider issues a common ID corresponding to a terminal ID of the TV terminal 3 to which the VOD server 1 of the VOD provider distributes video data. The common ID serves to allow the common server 2 to recognize plural terminal IDs as belonging to the same user. Then, the common server 2 stores a set of the issued common ID and the terminal ID. Therefore, even when the user has plural TV terminals 3, the plural TV terminals 3 can be recognized as belonging to a single user based on the common ID and not based on the charging ID which is personal information of the user, whereby the plural TV terminals can be managed as belonging to the same user.

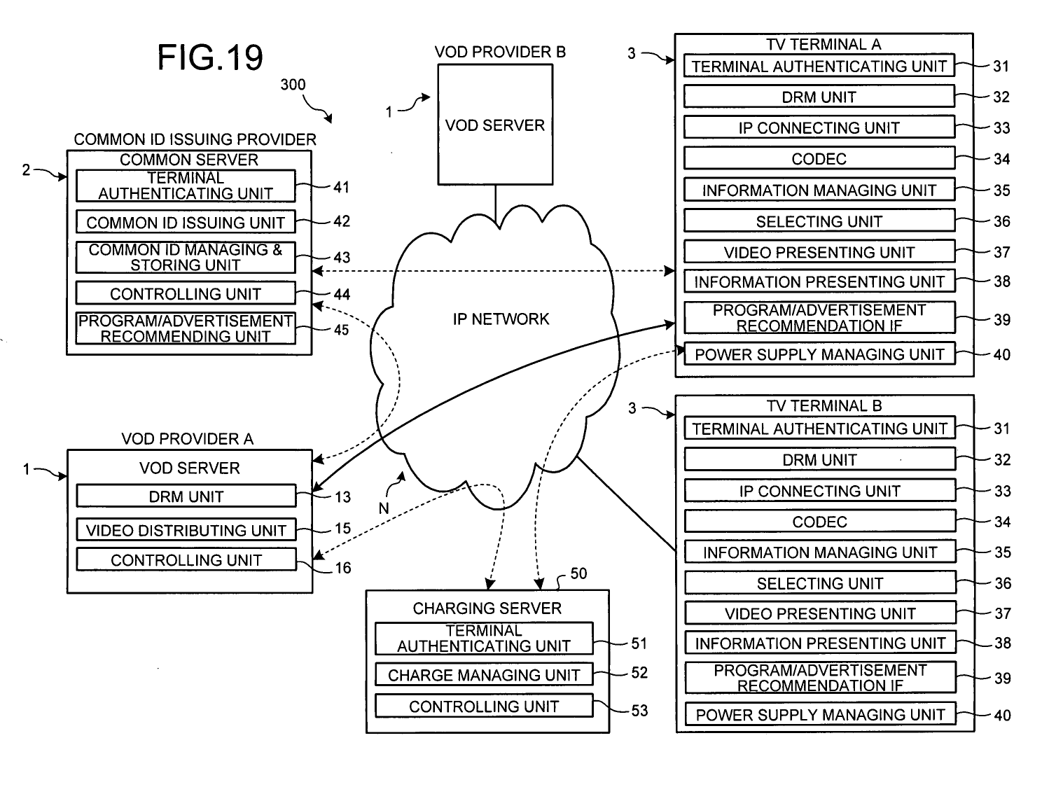

A third embodiment of the present invention will be described with reference to FIGS. 19 to 21. The same components in the third embodiment as the components in the first or the second embodiment will be denoted by the same reference characters and the description thereof will not be repeated.

FIG. 19 is a schematic block diagram of a functional structure of a VOD system 300 according to the third embodiment of the present invention. As shown in FIG. 19, in the VOD system 300 of the third embodiment, the VOD server 1 of the VOD provider does not includes the terminal authenticating unit 11 and the charge managing unit 12. The VOD system 300 of the third embodiment includes, instead, a charging server 50 which belongs to a charging provider and functions as a charging unit. The charging server 50 has a terminal authenticating unit 51 and a charge managing unit 52. In this regard, the VOD system 300 of the third embodiment is different from the VOD system 200 of the second embodiment. The charging server 50 has a similar hardware configuration as the configuration of the VOD server 1 or the common server 2, though a ROM or a HDD provided inside stores a different program.

The terminal authenticating unit 51 of the charging server 50 of the charging provider has a function of authenticating the terminal, and serves to check whether the TV terminal 3 is a subscribing receiving terminal or not and authenticate the subscribing terminal. The charge managing unit 52 has a function of managing the charging, and serves to charge the TV terminal 3 which is a subscribing receiving terminal according to the distributed video program. A controlling unit 53 has a function of controlling respective units in the charging server 50.

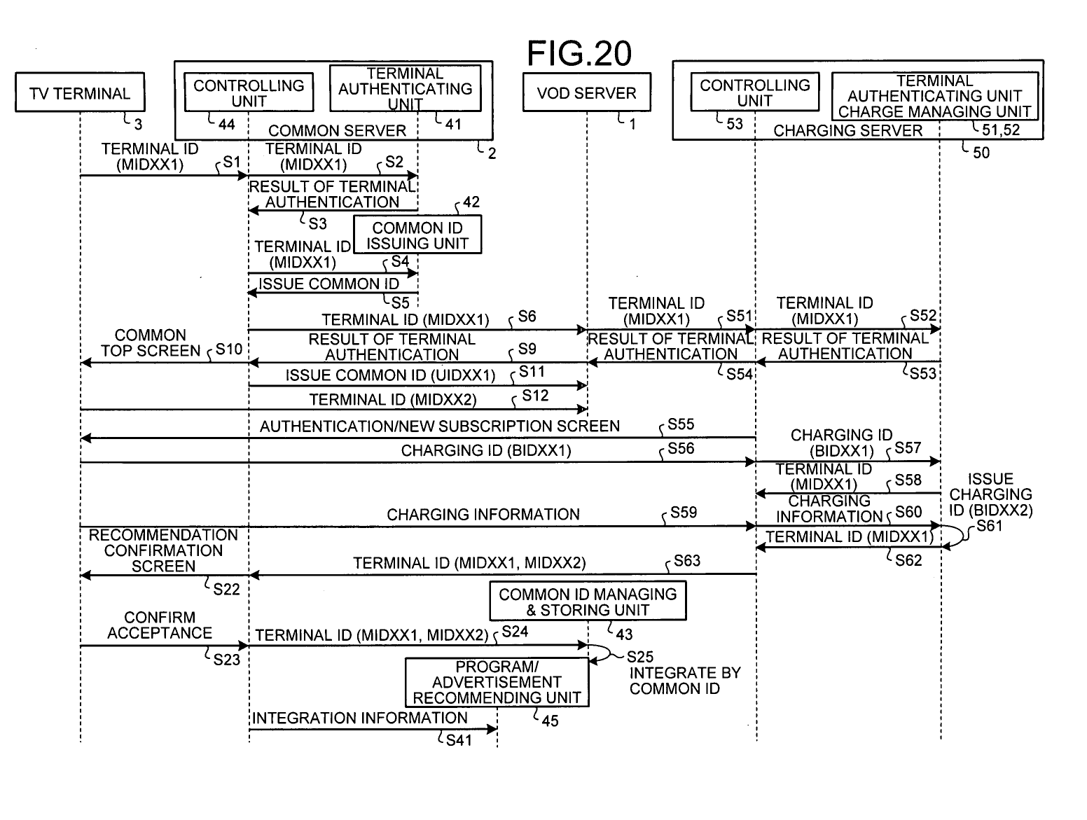

FIG. 20 is a sequence diagram of a process in the VOD system 300. The sequence diagram of FIG. 20 is different from the sequence diagram of FIG. 16 of the second embodiment in the following points.

The VOD server 1 sends the terminal ID (MIDXX1) sent from the common server 2 to the charging server 50 (step S51). The terminal authenticating unit 51 and the charge managing unit 52 of the charging server 50 check whether the TV terminal is a subscribing receiving terminal or not according to the received terminal ID (MIDXX1) and authenticate the subscribing receiving terminal (step S52).

The terminal authenticating unit 52 of the charging server 50 checks the received terminal ID (MIDXX1) for authentication, and if the received terminal ID is authentic, the result of authentication is sent to the charge managing unit 52. The charge managing unit 52 performs a charge authentication. When the charge managing unit 52 authenticates the received terminal ID (MIDXX1), the result of terminal authentication is sent to the controlling unit 53 of the charging server 50 (step S53). A process to be performed when the terminal is not authenticated will not be described here.

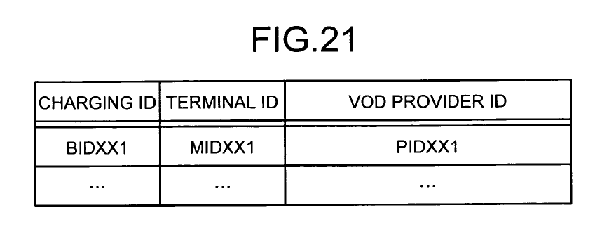

An example of data of subscription information stored by the terminal authenticating unit 51 and the charge managing unit 52 of the charging server 50 is shown in FIG. 21. The subscription information shown in FIG. 21 includes a VOD provider ID indicating the subscribed VOD provider, the charging ID, and the terminal ID in association with each other. In the example of FIG. 21, it can be seen that the user subscribes to the VOD provider having the VOD provider ID (PIDXX1) using the terminal with the terminal ID (MIDXX1) and the user is charged by the charging ID (VIDXX1). Here, three IDs are shown in one-to-one correspondence, though one or more IDs may be associated with each other and stored as necessary.

On receiving the result of terminal authentication, the controlling unit 53 of the charging server 50 sends the result of authentication to the VOD server 1 of the VOD provider (step S54). In response thereto, the VOD server 1 of the VOD provider sends the result of authentication to the common server 2 of the common ID issuing provider (step S9).

On receiving the result of terminal authentication, the controlling unit 44 of the common server 2 opens the common TOP screen on the monitor 9 of the TV terminal 3 accordingly (step S10). In addition, the controlling unit 44 of the common server 2 sends a common ID (UIDXX1) corresponding to the terminal ID (MIDXX1) to the VOD server 1 of the VOD provider to which the user subscribes based on the result of terminal authentication (step S11). When the common ID is issued, the issued common ID can be managed together with the terminal ID and the viewing history in the VOD server 1.

When the user selects the VOD provider C, which is not displayed as a provider to which the user subscribes (see FIG. 9), the terminal ID (MIDXX2) is sent from the TV terminal 3 to the VOD server 1 of the VOD provider C (step S12).

On receiving the terminal ID (MIDXX2), the VOD server 1 sends the terminal ID (MIDXX1) sent from the common server 2 to the charging server 50 (step S51). The charging server 50, similarly to steps S52 and S53, performs authentication of the terminal ID (MIDXX2). When the terminal ID (MIDXX2) is not in the subscription information as shown in FIG. 21, the controlling unit 53 of the charging server 50 sends the authentication/new subscription screen as shown in FIG. 10 to the TV terminal 3 and display the sent screen on the monitor 9 (step S55).

If the user already has a charging ID (BIDXX1) for the VOD provider C, the user inputs the charging ID (BIDXX1) into a charging ID input box 201 and selects a charging ID deliver button (step S56). In the description, the charging ID is “BIDXX1” for simplicity. The charging ID, however, can be one or more of the name of the user, address, bank account number for charging, mail address, or the like, as far as the information can be used for charging the user. If the user subscribes to the VOD provider C using a different terminal ID (for example, when the user buys a new TV terminal), the TV terminal (new TV terminal) may not be displayed as a subscribing receiving terminal as shown in FIG. 9, though the user may possess the charging ID.

On receiving the charging ID (BIDXX1) in step S56, the controlling unit 53 of the charging server 50 sends the charging ID (BIDXX1) to the charge managing unit 52 (step S57). The charge managing unit 52 searches the subscription information as shown in FIG. 21 to check if the charging ID (BIDXX1) already-exists or not. When the charging ID (BIDXX1) already exists, the terminal ID (MIDXX1) stored in association with the charging ID is sent to the controlling unit 53 of the charging server 50 (step S58). Then, it can be known that the terminal ID (MIDXX2) is used by the user who uses the terminal ID (MIDXX1). Therefore, the terminal ID (MIDXX1) and the terminal ID (MIDXX2) are stored in association with the charging ID (BIDXX1) in the subscription information as shown in FIG. 21 so that the TV terminals corresponding to the terminal IDs (MIDXX1) and (MIDXX2) can be known to have the same charging ID.

On the other hand, when the user selects a link 203 on the authentication/new subscription screen (see FIG. 10) displayed in step S55 to open the subscription screen for subscribing to the VOD provider C, charging information which enables charging of the user for the subscription to the VOD provider C is sent to the charging server 50 of the charging provider (step S59). The charging information is sent to the charge managing unit 52 (step S60). The charge managing unit 52 searches to check whether the charging information already exists in the subscription information as shown in FIG. 21.

When the charging information received by the charge managing unit 52 in step S60 does not exist in the subscription information shown in FIG. 21, a new charging ID (BIDXX2) is issued. The new charging ID (BIDXX2) is stored in association with the terminal ID (MIDXX2) as the subscription information as shown in FIG. 21 (step S61). Though not specifically shown in the sequence diagram of FIG. 20, the user may be notified of the newly issued charging ID (BIDXX2).

On the other hand, when the charging information received by the charge managing unit 12 in step S60 already exists in the subscription information as shown in FIG. 21, the terminal ID (MIDXX1) stored in association with the corresponding charging ID (BIDXX1) of the charging information is sent to the controlling unit 53 of the charging server 50 (step S62). When plural terminal IDs are stored in association with the charging ID (BIDXX1), all the stored terminal IDs are sent to the controlling unit 53 of the charging server 50 in step S62. Then, it can be known that the terminal IDs (MIDXX2) and (MIDXX1) are used by the same user. In the subscription information as shown in FIG. 21, the terminal IDs (MIDXX1) and (MIDXX2) are stored in association with the charging ID (BIDXX1).

When it is known that the terminal IDs (MIDXX1) and (MIDXX2) are used by the same user, the terminal IDs (MIDXX1) and (MIDXX2) are sent to the common server 2 of the common ID issuing provider (step S63). On receiving the set of terminal IDs, the common server 2 sends the recommendation confirmation screen as shown in FIG. 11 to the TV terminal 3 and make the monitor 9 display the same (step S22). The subsequent process is the same as the process in the second embodiment and the description thereof will not be repeated.

According to the third embodiment, the VOD system further includes the charging server 50. The charging server 50 has the terminal authenticating unit 51 and the charge managing unit 52. The terminal authenticating unit 51 checks whether the TV terminal 3 is a subscribing receiving terminal or not and authenticates the subscribing receiving terminal. The charge managing unit 52 charges the TV terminal 3 which is authenticated as a subscribing receiving terminal by the terminal authenticating unit 51 according to the distributed video data. Therefore, the VOD provider does not need to charge the user on its side, and the building of the VOD provider is facilitated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video distribution system comprising:
plural receiving terminals each having a terminal ID and configured to make a distribution request for video data, and to receive the video data distributed in response to the distribution request;
a video distribution apparatus configured to distribute the video data to the receiving terminal according to the distribution request; and
a common ID issuing and managing apparatus that includes a common ID issuing unit configured to issue a common ID so that the terminal IDs of the plural receiving terminals are treated as a same ID in the common ID issuing & managing apparatus,
a common ID storing unit configured to store the common ID and the plural terminal IDs in association with each other, and
a terminal authenticating unit that authenticates whether the common ID is in the common ID storing unit or not, the common ID being associated with the terminal ID of the receiving terminal to which the video data are to be distributed for the distribution request.

2. The video distribution system according to claim 1, wherein
the video distribution apparatus receives the common ID corresponding to the terminal ID of the receiving terminal from the common ID issuing & managing apparatus, and manages information on viewing history related with the distributed video data and the terminal ID of the receiving terminal to which the data is distributed in association with the common ID.

3. The video distribution system according to claim 2, wherein
the common ID issuing & managing apparatus gathers the information on viewing history related to the video data distributed by each of the video distribution apparatus and the common IDs of the receiving terminals to which the video data is distributed.

4. The video distribution system according to claim 1, wherein
the common ID issuing & managing apparatus includes
a selecting unit configured to allow a user to select whether to integrate terminal IDs of plural receiving terminals into one common ID and to manage the terminal IDs by the one common ID or not when the plural IDs of the plural receiving terminals are used by the user, and
a changing unit configured to change a content stored in the common ID storing unit so as to manage the plural terminal IDs by the one common ID when the user selects to integrate and manage the terminal IDs by the one common ID.

5. The video distribution system according to claim 1, wherein
the video distribution apparatus includes a recommending unit configured to manage information on viewing history of distributed video data and the terminal ID by the common ID, and to recommend a user of each of the receiving terminals to view various information according to the distributed video data, and
the recommending unit integrates information on viewing history for each of the terminal IDs when the terminal IDs are integrated and managed by another common ID.

6. The video distribution system according to claim 1, wherein
the common ID issuing & managing apparatus includes
a recommending unit configured to manage information on viewing history of video data distributed by the video distribution apparatus and the terminal ID by the common ID, and to recommend a user of each receiving terminal to view various information according to the distributed video data, and
the recommending unit integrates information on viewing history of each of the terminal IDs when the terminal IDs of the receiving terminals are integrated and managed by another common ID.

7. The video distribution system according to claim 1, further comprising
a charging apparatus that includes
a terminal authenticating unit configured to check whether a receiving terminal is a subscribing receiving terminal or not and authenticates the subscribing receiving terminal, and
a charge managing unit that charges the receiving terminal which is authenticated as the subscribing receiving terminal by the terminal authenticating unit according to video data distributed to the receiving terminal.

8. The video distribution system according to claim 1, wherein
the receiving terminal includes
a power supply managing unit configured to monitor disconnection from a power supply source, and
a disconnection notifying unit configured to notify the common ID issuing & managing apparatus that time of disconnection from the power supply source exceeds a predetermined time and to send the terminal ID of the receiving terminal to the common ID issuing & managing apparatus when the power supply managing unit determines that the time of disconnection from the power supply source exceeds the predetermined time, and
the common ID issuing & managing apparatus, on receiving the terminal ID and notification that the time of disconnection from the power supply source exceeds the predetermined time, deletes the terminal ID from a list of terminal IDs associated with the common ID stored in the common ID storing unit corresponding to the terminal ID.

9. A method of managing a receiving terminal of a video distribution service, comprising:
issuing a common ID from a common ID issuing & managing apparatus for a terminal ID of a receiving terminal to which a video distribution apparatus distributes video data according to a distribution request, the common ID serving for allowing the video distribution apparatus to treat the terminal IDs associated with the common ID as same; and
storing and managing the common ID in association with the terminal ID.

10. A common ID issuing and managing apparatus comprising:
a common ID issuing unit configured to issue a common ID so that terminal IDs of plural receiving terminals, which receive video data distributed from a video distribution apparatus, are treated as a same ID in the common ID issuing & managing apparatus,
a common ID storing unit configured to store the common ID and the plural terminal IDs in association with each other, and
a terminal authenticating unit that authenticates whether the common ID is in the common ID storing unit or not, the common ID being associated with the terminal ID of the receiving terminal to which the video data are to be distributed for the distribution request.
